(19) United States
(12) Patent Application Publication
(10) Pub. No.: US 2007/0193606 A1
(43) Pub. Date: Aug. 23, 2007

(54) Dishwashing machine with a self-closure mechanism for locking the door and method for operating the dishwashing machine

(75) Inventors: Egbert Classen, Wertingen (DE); Helmut Jerg, Giengen (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munich (DE)

(21) Appl. No.: 11/640,514

(22) Filed: Dec. 15, 2006

(30) Foreign Application Priority Data
Dec. 27, 2005 (DE) 10 2005 062 472.3

(51) Int. Cl. B08B 9/20; B08B 3/00

(52) U.S. Cl. 134/25.2; 134/56 D; 134/58 D; 134/58 DL; 134/57 DL

(57) ABSTRACT

A dishwashing machine (1) comprising a washing container (2) and devices (3, 4) for washing crockery is described in which an access opening (5) of the washing container (2) can be closed in a watertight manner by means of a door (6). In this case, a closure mechanism (7) is provided for locking the door (6) with the washing container (2) so that the door can be brought from a closed position into an operating position which seals the washing container (2) in a watertight manner. The closure mechanism (7) comprises at least one electrically triggered transmission member which can automatically bring the door from the closed position into the operating position and/or conversely.

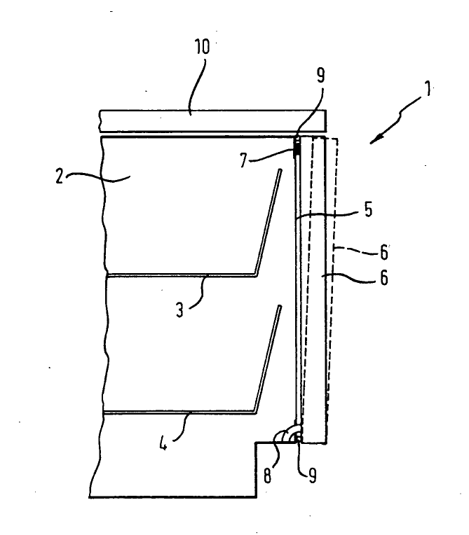

### BACKGROUND OF THE INVENTION

The invention relates to a dishwashing machine comprising a washing container and devices for washing crockery, in which an access opening of the washing container can be closed in a watertight manner by means of a door and comprising a closure mechanism for locking the door with the washing container from a closed position into an operating position which seals the washing container in a watertight manner.

The invention further relates to a method for operating a dishwashing machine comprising a washing container and devices for washing dishes, in which an access opening of the washing container can be closed in a watertight manner by means of a door and comprising a closure mechanism for locking the door with the washing container from a closed position into an operating position which seals the washing container in a watertight manner.

In conventional dishwashing machines, locking and unlocking the door with the washing container is performed manually by the user of the dishwashing machine. The closure mechanism usually has two components of which one is disposed on the washing container and the other is disposed on the door. These two components can be brought into engagement with one another so that a watertight operating position of the door can be achieved. In the operating position the door is pressed firmly against the washing container with an interposed seal so that this is closed in a watertight and odour-proof manner. Frequently, the user of the dishwashing machine only brings the door into the operating position when a washing program sequence for cleaning the dishes is to be carried out. During a standstill time in which the door of the dishwashing machine is usually actuated many times for filling this with crockery, after each opening the door is merely brought into a closed position in which the access opening is merely visually closed. In this closed position, the components of the closure mechanism are not brought into engagement with one another so that no water-tight and odour-proof closure is provided. As a result, when the standstill time of the dishwashing machine is fairly long, decomposition processes of food residues in the washing container can generate unpleasant odours which flow towards the user every time the door is opened.

### BRIEF SUMMARY OF THE INVENTION

The object of the present invention is to provide a dishwashing machine and a method for operating a dishwashing machine which at least reduce the formation of odours and thereby make handling the machine more comfortable for the user.

The object is achieved with a dishwashing machine having the features of claim 1 as well as a method having the features of claim 7. Advantageous embodiments are obtained from the dependent claims.

A dishwashing machine according to the invention comprises a washing container and devices for washing dishes, in which an access opening of the washing container can be closed in a watertight manner by means of a door. A closure mechanism is furthermore provided for locking the door with the washing container from a closed position into an operating position which seals the washing container in a watertight manner. The closure mechanism has at least one electrically controllable transmission member which can bring the door from a closed position into the operating position and/or conversely.

In the method according to the invention for operating the dishwashing machine described above, an electrically triggered closure mechanism is actuated for the transition from the closed position to the operating position and/or conversely.

By providing an electrically actuated or electrically triggered closure mechanism, the door can be conveniently and optionally automatically be brought from the closed position into the watertight-sealing operating position after every closure so that the interior of the washing container is closed in an airtight manner and the decomposition process of food residue in the interior is reduced during a fairly long standstill time. In addition, it can be automatically ensured that the door is in its operating position when starting a washing program sequence. The transition from the closed position to the operating position no longer needs to be performed manually by the user in the invention.

The automatic closure or the automatic opening of the door is made possible by the provision of an electrically triggered transmission member which acts on a closure mechanism when triggered. The transmission member preferably has at least one transmission means each having two electrodes and a polymer electrically operatively connected thereto in which a first section of the polymer can be deflected depending on an electric field generated by the two electrodes. Depending on the deflection of the first section of the polymer required to actuate the closure mechanism, it can be provided that a transmission member has a plurality of transmission means each having two electrodes and a polymer electrically operatively connected to these electrodes. As a result of the free design of the polymer, these transmission members can be produced in almost any form. Since such a transmission member completely dispenses with any components to be driven mechanically, such as a motor, gears and the like, for example, the transmission member can be constructed particularly simply. In particular, it is also possible to provide the transmission member in those area of the dishwashing machine which come in contact with washing solution. In this case, the closure mechanism can have an arbitrary number of such electrically triggered transmission members. In particular, one transmission member can be provided for opening the closure mechanism (whereby the door is brought from the operating position into the closed position) and one transmission member can be provided to lock the closure mechanism (whereby the door can be brought from the closed position into the operating position).

Transmission members of the type described are known from the prior art and are described there as an electroactive polymer, dielectric elastomer, electroelastomer or EPAM. The structure and operating mode of such a transmission member is described, for example, in U.S. Pat. No. 6,545,384 B1. A plurality of exemplary embodiments for such transmission members such as those used within the scope of the present invention can be deduced from US 2003/0218 403 A1.

To amplify the deflection as well as to increase the force produced by the polymer, a second section of the polymer can be provided with a support means which supports the conversion of electrical energy into mechanical energy of the polymer. The support means can comprise any framework connected to the polymer or a spring.

In a further embodiment, it is provided that the closure mechanism comprises a snap lock and the transmission means is operatively connected to the snap lock. As a result, a conventional closure mechanism such as is used in conventional dishwashing machines can be further used, whereby the functionality of the handle which has hitherto been accessible for the user in the region of the front panel can be replaced by the transmission member. It is naturally also feasible that the transmission member is provided in addition to the handle elements still used, for locking and unlocking the door with the washing container. By this means, access to the dishwashing machine would also be ensured in the event of a power failure.

In a further embodiment it is provided that the door is pivotally connected to the washing container by means of a pivot joint and the transmission means is operatively connected to the pivot joint for the purpose of executing a rotary movement of the door with respect to the washing container. This can support the transition of the door from the closed position to the operating position and/or conversely.

The closure mechanism for transition from the closed position into the operating position and/or conversely can be actuated manually by a user or by a sensor. Should such a transfer be made manually by a user of the dishwashing machine, an additional button can be provided for this purpose in a control element, for example, which opens or, when this is actuated repeatedly closes the door. However, the transmission member of the closure mechanism can also be actuated depending on the selection, i.e. the beginning of a washing program sequence. Thus, for example, when a particular pre-determined washing program sequence is selected by the user of the dishwashing machine, a transition can be made from the closed position to the operating position of the door. It is furthermore feasible that after a washing program sequence has ended, a transition from the operating position to the closed position of the door takes place so that water vapour located in the interior of the washing container can now escape through the opening which has new been formed, thus advantageously influencing the drying of the crockery. Sensor actuation of the closure mechanism can be effected, for example, by means of a pressure switch which is actuated with the opening and closing of the door. The sensor can likewise be of an optical nature and can detect a movement or approach of a part of the body in the direction of the control element and bring about the locking or unlocking of the door with the washing container depending on the operating state of the dishwashing machine.

The method according to the invention has the same advantages as have been described hereinbefore in connection with the dishwashing machine according to the invention.

In this method for actuating the closure mechanism at least one transmission member comprising at least one transmission means each having two electrodes and a polymer electrically operatively connected thereto is driven so that a first section of the polymer is deflected depending on an electric field generated by the two electrodes and acts on the closure mechanism and/or the door. Depending on the configuration of the transmission member and the arrangement of the transmission member and the arrangement of the transmission member relative to the closure mechanism, the transmission member can produce a pull or push on the closure mechanism and/or the door. Depending on the design, the transmission member can be used to lock or unlock the door with the washing container.

In one embodiment it is provided that the actuation of the closure mechanism takes place automatically when the door is brought into the closed position. This can take place, for example, after every opening and closing of the dishwashing machine for sorting crockery in order to close the dishwashing machine in a watertight and odour-tight manner. The actuation of the closure mechanism can be coupled to the sensor signal.

Alternatively, it can be provided that the triggering of the transmission member is coupled to the start of a washing program sequence or is effected manually by the user. The latter can take place for example, by actuating a control element of the dishwashing machine.

### BRIEF DESCRIPTION OF THE DRAWINGS

The invention will now be explained in greater detail with reference to an arrangement for executing the method of the present invention illustrated in the sole FIGURES of the drawings, in which the sole FIGURE of the drawings is a side elevational schematic view, in partial section, of a dishwashing machine.

The invention is explained hereinafter with reference to an exemplary embodiment in the FIGURE. The single FIGURE is a schematic diagram showing a section through the dishwashing machine 1 according to the invention.

### DETAILED DESCRIPTION OF THE INVENTION

The dishwashing machine 1 comprises in a known fashion a housing 1 and a door 6 which gives access to the treatment chamber of the dishwashing machine 1. A peripheral seal 9 for secure closure of the treatment chamber is provided between the door 6 and a washing container 2. A cover plate 10 is provided on the upper side of the housing. In a known manner, the dishwashing machine 1 comprises devices 3, 4 for washing crockery. As an example, these are shown as crockery baskets 3, 4 in the FIGURES, each having allocated spray devices (not shown).

The door 6 is mechanically connected to the washing container 2 by means of a pivot joint 8, e.g. a hinge. The pivot joint 8 forms in a known manner a hinged connection of the door for pivotal opening with respect to the washing container 2. In the FIGURE the door is shown once with broken lines in a closed position and once with a continuous line in an operating position. In the operating position the door 6 is connected to the washing container 2 in a watertight and odour-proof manner. In this state, the door 6 is locked to the housing 2 by means of a closure mechanism.

The closure mechanism 7 comprises, for example, in a known fashion a lock plate (not shown) attached to the washing container and a snap hook pivotable between a plurality of positions (also not shown), which is affixed to the door 6. In the operating position, the snap hook engages in the lock plate so that the door is pulled to the washing container 2 with a predefined force.

In the closed position shown in the FIGURE, the access aperture to the washing container 2 is closed by the door 6 (visually), but the lock plate and snap hook of the closure mechanism 7 are not interlocked so that the door can be opened by applying a small force (and without actuating any unlocking element).

A push on the door in the direction of the washing container is sufficient to bring the snap hook and the lock plate of the closure mechanism 7 into their locking position. For unlocking the closure mechanism, a handle or unlocking element is provided in the area of the control panel in conventional dishwashing machines, which element acts mechanically on the snap hook in order to release this from the lock plate.

Within the scope of the present invention, the closure mechanism is provided with an electrically triggered transmission member (not shown) which makes the handle or unlocking element described above superfluous. The electrically triggered transmission member preferably has at least one transmission means each having two electrodes and a polymer electrically operatively connected to said electrodes, in which a first section of the polymer can be deflected depending on an electric field generated by two electrodes. This deflection is used to lock or unlock the lock plate and snap hook. Depending on the choice of electroactive polymer, magnitude of triggering voltage, configuration and provision of a support means, the transmission member is capable of causing a pull or a push. A plurality of transmission members can be provided to achieve locking or unlocking. Each of the transmission members can optionally be fitted with any arbitrary number of transmission means. The number of the transmission means depends on the desired deflection of the polymer.

A description of the operating mode of the transmission means can be obtained, for example, from U.S. Pat. No. 6,545,384 B1.

The present invention provides a dishwashing machine which has a “motor lock” which makes the provision of a conventional handle element for locking and unlocking the door with the washing container superfluous. The door is therefore brought automatically from a closed position i.e. an almost closed position, by the transmission member i.e., without any manual intervention by the user, into the operating position. In the operating position the washing container is closed in a watertight manner by the door 6. In this way, the design of the dishwashing machine is simplified. In addition, any unpleasant odour formation can be reduced. This is made possible by the electrical actuation of the closing mechanism allowing automatic closure of the door in its operating position e.g. after every opening. The transmission member can be fitted with other components, e.g. an electric motor, hydraulic or pneumatic drives.

### REFERENCE LIST

1 Dishwashing machine
2 Washing container
3 Crockery basket
4 Crockery basket
5 Access opening
6 Door
7 Closure mechanism
8 Pivot joint
9 Seal
10 Cover plate

1-10. (canceled)

11. A dishwashing machine comprising:
a washing container having an access opening;
a device for washing crockery disposed within the washing container;
a door movable among a crockery loading position in which access to the washing container via the access opening of the washing container can be had for disposing crockery within the washing container, an access closed position in which access to the washing container via the access opening of the washing container for disposing crockery within the washing container can no longer be had, and a wash operating position in which the door is closed in a watertight manner relative to the washing container; and
a closure mechanism for locking the door. When the door is disposed in its access closed position, into its wash operating position, the closure mechanism including at least one electrically triggered transmission member operable to automatically execute at least one of locking the door, when the door is disposed in its access closed position, into its wash operating position and releasing the door from its wash operating position.

12. The dishwashing machine according to claim 11, wherein the transmission member includes at least one transmission means each having two electrodes and a polymer electrically operatively connected thereto in which a first section of the polymer can be deflected depending on an electric field generated by the two electrodes.

13. The dishwashing machine according to claim 12, wherein a second section of the polymer is provided with a support means which supports the conversion of electrical energy into mechanical energy of the polymer.

14. The dishwashing machine according to claim 12, wherein the closure mechanism includes a snap lock and the transmission means is operatively connected to the snap lock.

15. The dishwashing machine according to claim 12, wherein the door is pivotally connected to the washing container by means of a pivot joint and the transmission means is operatively connected to the pivot joint for the purpose of executing a rotary movement of the door with respect to the washing container.

16. The dishwashing machine according to claim 12, wherein the closure mechanism can be actuated manually by a selected one of a user and a sensor for transition of the door, when the door is disposed in its access closed position, into its wash operating position and for releasing the door from its wash operating position.

17. A method for operating a dishwashing machine comprising:
in a dishwasher having a washing container having an access opening, a device for washing crockery disposed within the washing container, a door movable among a crockery loading position in which access to the washing container via the access opening of the washing container can be had for disposing crockery within the washing container, an access closed position in which access to the washing container via the access opening of the washing container for disposing crockery within the washing container can no longer be had, and a wash operating position in which the door is closed in a watertight manner relative to the washing container, and a closure mechanism for locking the door, when the door is disposed in its access closed position, into its wash operating position, actuating a transmission member of the closure mechanism operable to automatically execute at least one of locking the door, when the door is disposed in its access closed position, into its wash operating position and releasing the door from its wash operating position.

18. The method according to claim 17, wherein actuating a transmission member of the closure mechanism includes actuating at least one transmission member comprising at least one transmission means each having two electrodes and a polymer electrically operatively connected thereto is driven so that a first section of the polymer is deflected depending on an electric field generated by the two electrodes and acts on the closure mechanism and/or the door.

19. The method according to claim 17, wherein actuating a transmission member of the closure mechanism includes actuating the transmission member automatically when the door is brought into the access closed position.

20. The method according to claim 17, wherein actuating a transmission member of the closure mechanism includes actuating the transmission member as a function of a selected one of the start of a washing program sequence and a manual engagement by the user of a selected component of the dishwasher.
